(19) United States
(12) Patent Application Publication
(10) Pub. No.: US 2026/0367455 A1
(43) Pub. Date: Nov. 19, 2026

(54) DISPLAY DEVICE, METHOD FOR MANUFACTURING THE SAME, AND ELECTRONIC DEVICE INCLUDING THE SAME

(71) Applicant: Samsung Display Co., Ltd., Yongin-si (KR)

(72) Inventor: Yong Seok KIM, Yongin-si (KR)

(21) Appl. No.: 19/455,664

(22) Filed: Jan. 21, 2026

(30) Foreign Application Priority Data
May 13, 2025 (KR) 10-2025-0062077

(51) Int. Cl. G02F 1/155

(52) U.S. Cl. CPC G02F 1/155

(57) ABSTRACT

A display device including a substrate, a pixel electrode above the substrate, an electrochromic layer above the pixel electrode and configured to block or transmit light according to a redox reaction, a counter layer spaced apart from the pixel electrode and the electrochromic layer, configured to store ions, and including a side portion on at least one side surface of the electrochromic layer, and a top portion connected to the side portion and defining an opening overlapping the electrochromic layer in a thickness direction of the substrate, a common electrode above the counter layer, and an electrolyte layer between the electrochromic layer and the counter layer.

### CROSS-REFERENCE TO RELATED APPLICATION

The present application claims priority to and the benefit of Korean Patent Application No. 10-2025-0062077, filed on May 13, 2025, in the Korean Intellectual Property Office, the entire disclosure of which is incorporated herein by reference.

### BACKGROUND

### 1. Field

The present disclosure relates to a display device, a method for manufacturing the same, and an electronic device including the same.

### 2. Description of the Related Art

With the advancement of the information society, various types of display devices have been developed to display information. For example, an electrochromic display is a display device that makes pixels transparent or displays colors of pixels using a redox reaction.

However, in a conventional electrochromic display, air often enters during the process of filling each electrolyte layer. The air contained in the electrolyte layers may block the movement of the electrolytes, thereby reducing or preventing electrochromism and deteriorating the performance of the electrochromic display.

### SUMMARY

One aspect of the present disclosure provides a display device with improved performance by effectively discharging air from an electrolyte layer.

Another aspect of the present disclosure provides a method for manufacturing a display device with improved performance by effectively discharging air from an electrolyte layer.

Another aspect of the present disclosure provides an electronic device including a display device with improved performance by effectively discharging air from an electrolyte layer.

The aspects of the present disclosure are not limited to those mentioned above, and other aspects not explicitly stated will be clearly understood by those skilled in the art based on the following description.

According to an aspect of the present disclosure, a display device incudes a substrate, a pixel electrode above the substrate, an electrochromic layer above the pixel electrode and configured to block or transmit light according to a redox reaction, a counter layer spaced apart from the pixel electrode and the electrochromic layer, configured to store ions, and including a side portion on at least one side surface of the electrochromic layer, and a top portion connected to the side portion and defining an opening overlapping the electrochromic layer in a thickness direction of the substrate, a common electrode above the counter layer, and an electrolyte layer between the electrochromic layer and the counter layer.

The common electrode may be on the side portion and the top portion.

The common electrode may contact the side portion and the top portion.

The common electrode may be spaced apart from the opening in plan view.

The side portion of the counter layer may include a first side surface, a second side surface opposite to the first side surface, a third side surface connecting one side of the first side surface and one side of the second side surface, and a fourth side surface connecting another side of the first side surface and another side of the second side surface, wherein the top portion is connected to the first side surface, the second side surface, the third side surface, and the fourth side surface.

The common electrode may cover the top portion, the first side surface, the second side surface, the third side surface, and the fourth side surface.

A planar shape of the opening may be substantially equal to a planar shape of the electrochromic layer.

The side portion may include a first side surface, and a second side surface opposite to the first side surface.

The electrochromic layer may include a top surface, a bottom surface opposite to the top surface, a first surface connecting one side of the top surface and one side of the bottom surface, a second surface opposite to the first surface, a third surface connecting one side of the first surface and one side of the second surface, and a fourth surface connecting another side of the first surface and another side of the second surface, wherein the first side surface of the counter layer is on the first surface of the electrochromic layer, wherein the second side surface of the counter layer is on the second surface of the electrochromic layer, and wherein the counter layer is not on the third surface and the fourth surface of the electrochromic layer.

The first side surface and the second side surface of the counter layer may extend in a first direction, wherein the first side surface defines a first opening overlapping the first surface of the electrochromic layer in a second direction that is orthogonal to the first direction, and wherein the second side surface defines a second opening overlapping the second surface of the electrochromic layer in the second direction.

The top portion may have a circular or elliptical planar shape, wherein the side portion has a curved surface.

According to an aspect of the present disclosure, a display device incudes a substrate, a pixel electrode above the substrate, an electrochromic layer above the pixel electrode and configured to block or transmit light according to a redox reaction, a counter layer spaced apart from the pixel electrode and the electrochromic layer, configured to store ions, and including a top portion and a side portion on at least one side surface of the electrochromic layer, connected to the top portion, and defining a first opening overlapping the electrochromic layer and a second opening opposite to the first opening in a first direction that is orthogonal to a thickness direction of the substrate, a common electrode above the counter layer, and an electrolyte layer between the electrochromic layer and the counter layer.

The first opening may extend from a lower side of the side portion to a lower side of the top portion.

The side portion may further define a third opening overlapping the electrochromic layer and a fourth opening opposite the third opening in a second direction that is orthogonal to the thickness direction of the substrate and the first direction.

The third opening may extend from a lower side of the side portion to a lower side of the top portion.

The common electrode may be on the side portion and the top portion.

The common electrode may contact the side portion and the top portion.

The common electrode might not overlap the first opening and the second opening in the first direction.

According to an aspect of the present disclosure, a method for manufacturing a display device includes sequentially forming a pixel electrode and an electrochromic layer above a first substrate, forming a first photoresist pattern above the electrochromic layer, forming a counter layer above the first photoresist pattern, forming a second photoresist pattern above a portion of the counter layer, etching the counter layer and removing the second photoresist pattern, forming a common electrode above the counter layer, forming a third photoresist pattern above a portion of the common electrode, etching the common electrode and removing the first and third photoresist patterns, and filling an electrolyte layer between the electrochromic layer and the counter layer and above the common electrode.

According to an aspect of the present disclosure, an electronic device incudes a display module configured to display an image, and a processor configured to deliver an image data signal to display the image on the display module, wherein the display module includes a substrate, a pixel electrode above the substrate, an electrochromic layer above the pixel electrode and configured to block or transmit light according to a redox reaction, a counter layer spaced apart from the pixel electrode and the electrochromic layer, configured to store ions, and including a side portion on at least one side surface of the electrochromic layer, and a top portion connected to the side portion and defining an opening overlapping the electrochromic layer in a thickness direction of the substrate, a common electrode above the counter layer, and an electrolyte layer between the electrochromic layer and the counter layer.

According to the display device, the method, and the electronic device of the present disclosure, an opening may be formed in, or defined by, a counter layer and a common electrode. During the process of filling an electrolyte layer, the air layer present between the counter layer and the electrochromic layer may be suitably discharged to the outside of the structural portions formed by the counter layer and the common electrode through the opening. Through this, the air layer included in the electrochromic layer may be effectively removed, thereby reducing or preventing performance degradation of an electrochromic display caused by the air layer.

It should be noted that the aspects of the present disclosure are not limited to those described above, and other aspects of the present disclosure will be apparent from the following description.

### BRIEF DESCRIPTION OF THE DRAWINGS

The above and other aspects of the present disclosure will become more apparent by describing embodiments thereof in detail with reference to the attached drawings, in which:

FIG. 1 is a front view of a display device according to some embodiments of the present disclosure.

FIG. 2 is an enlarged layout view illustrating an example of region A in FIG. 1.

FIG. 3 is an enlarged perspective view of a pixel in FIG. 2.

FIG. 4 is a cross-sectional view, taken along the line I-I′ of FIG. 2, of an example of the display panel 100.

FIG. 5 is a cross-sectional view, taken along the line I-I′ of FIG. 2.

FIG. 6 is an enlarged layout view of another example of region A in FIG. 1.

FIG. 7 is a cross-sectional view taken along the line J-J′ in FIG. 6.

FIG. 8 is an enlarged layout view illustrating another example of region A in FIG. 1.

FIG. 9 is an enlarged perspective view of an example of a pixel in FIG. 8.

FIG. 10 is an enlarged perspective view of another example of the pixel in FIG. 8.

FIG. 11 is an enlarged perspective view illustrating yet another example of the pixel in FIG. 8.

FIG. 12 is an enlarged perspective view illustrating another example of the pixel in FIG. 8.

FIG. 13 is an enlarged perspective view of the pixel in FIG. 2.

FIG. 14 is an enlarged perspective view illustrating another example of the pixel in FIG. 2.

FIG. 15 is an enlarged layout view illustrating another example of region A in FIG. 1.

FIG. 16 is an enlarged perspective view illustrating one example of a pixel in FIG. 15.

FIG. 17 is a flowchart illustrating a method for manufacturing a display device according to some embodiments of the present disclosure.

FIGS. 18-27 are diagrams for explaining the method of FIG. 17.

FIG. 28 is a block diagram of an electronic device including the display device according to some embodiments of the present disclosure.

FIG. 29 illustrates schematic diagrams of electronic devices according to various embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, if a first part is described as being arranged “on” a second part, this indicates that the first part is arranged at an upper side or a lower side of the second part without the limitation to the upper side thereof on the basis of the gravity direction.

Further, the phrase “in a plan view” means if an object portion is viewed from above, and the phrase “in a schematic cross-sectional view” means if a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that if an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, if a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, if a portion of a layer, a film, an area, a plate, or the like is formed on another portion, a forming direction is not limited to an upper direction but includes forming the portion on a side surface or in a lower direction. On the contrary, if a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that if an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When "C to D" is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. The terms or words used in the present specification and claims are not to be limitedly interpreted as general or dictionary meanings and should be interpreted as meanings and concepts that are consistent with aspects of the present disclosure on the basis that an inventor can be their own lexicographer to appropriately define concepts of terms to describe the embodiments in the best way.

As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/- 5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

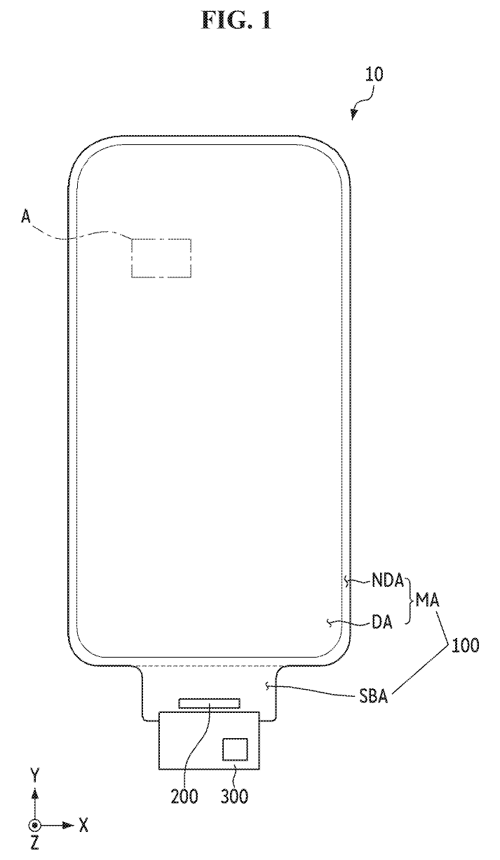

FIG. 1 is a front view of a display device according to some embodiments of the present disclosure.

Referring to FIG. 1, a display device 10 may be applied to a portable electronic device, such as a mobile phone, a smart phone, a tablet personal computer (tablet PC), a mobile communication terminal, an electronic notepad, an electronic book reader, a portable multimedia player (PMP), a navigation device, or an Ultra Mobile PC (UMPC). Alternatively, the display device 10 may be applied as a display unit of a television, a laptop computer, a monitor, an advertisement board, or an Internet of Things (IoT) device. Yet alternatively, the display device 10 may be applied to a wearable device, such as a smart watch, a watch phone, a glasses-type display, or a head mounted display (HMD). Still alternatively, the display device 10 may be applied to a display mounted in a vehicle, such as an instrument panel, a center fascia of a vehicle, a Center Information Display (CID) on a dashboard of a vehicle, a room mirror display replacing a side mirror, or a display for rear-seat entertainment on the rear surface of a front seat.

The display device 10 may be a display device, such as an organic light-emitting display using organic light-emitting diodes (OLEDs), a quantum-dot light-emitting display including a quantum-dot emission layer, an inorganic light-emitting display including an inorganic semiconductor, a micro or nano light-emitting display using micro or nano light-emitting diodes (micro LEDs or nano LEDs), or an electrochromic display using a redox reaction. The display device 10 will hereinafter be described mainly as an electrochromic display device, but the present disclosure is not limited thereto.

The display device 10 includes a display panel 100, a display-driving circuit 200, and a display circuit board 300.

The display panel 100 may be formed as a flat rectangle having short sides in a first direction (e.g., an X-axis direction) and long sides in a second direction (e.g., a Y-axis direction) intersecting the first direction. The corners where the short sides in the first direction and the long sides in the second direction meet may be rounded with a curvature (e.g., a predetermined curvature) or may be right-angled. The planar shape of the display panel 100 is not limited to a rectangle, and the display panel 100 may also be implemented in other polygonal shapes, circular, or elliptical shapes. The display panel 100 may be formed flat but is not limited thereto. For example, the display panel 100 may include curved portions formed at left and right ends, having a constant or varying curvature. Additionally, the display panel 100 may be formed flexibly to be bendable, curvable, foldable, or rollable.

The display panel 100 includes a main area MA and a sub area SBA. The main area MA includes a display area DA for displaying an image and a non-display area NDA, which is a peripheral area around the display area DA. The display area DA includes pixels PX for displaying an image. The sub area SBA may protrude from one side of the main area MA in a direction opposite to the second direction.

FIG. 1 illustrates an example in which the sub area SBA is unfolded, but the sub area SBA may be bent, in which case, the sub area SBA may be positioned on the lower surface of the display panel 100. When the sub area SBA is bent, it may overlap the main area MA in a thickness direction (e.g., a Z-axis direction) of a substrate. The sub area SBA may accommodate the display-driving circuit 200.

The display-driving circuit 200 may generate signals and voltages for driving the display panel 100. The display-driving circuit 200 may be formed as an integrated circuit (IC) and may be attached to the display panel 100 using a chip-on-glass (COG) method, a chip-on-plastic (COP) method, or an ultrasonic bonding method, but is not limited thereto. For example, the display-driving circuit 200 may be attached to the display circuit board 300 using a chip-on-film (COF) method.

The display circuit board 300 may be attached to one end of the sub area SBA of the display panel 100. Accordingly, the display circuit board 300 may be electrically connected to the display panel 100 and the display-driving circuit 200. The display panel 100 and the display-driving circuit 200 may receive digital video data, timing signals, and driving voltages through the display circuit board 300. The display circuit board 300 may be a flexible printed circuit board, a printed circuit board, or a flexible film, such as a COF.

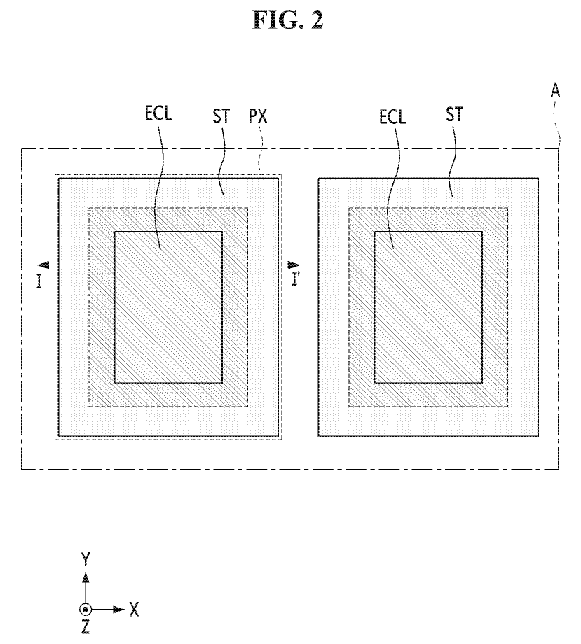

FIG. 2 is an enlarged layout view illustrating an example of region A in FIG. 1.

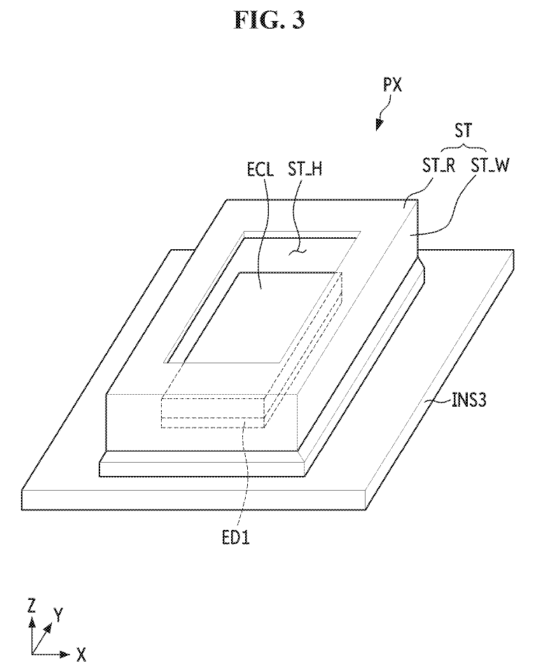

Referring to FIGS. 2 and 3, the display panel 100 may include pixels PX. The pixels PX may be the smallest units for transmitting light or displaying color. Each of the pixels PX may include an electrochromic layer ECL and a structural portion ST.

The electrochromic layer ECL may change color according to a redox reaction. For example, when oxidized, the electrochromic layer ECL may be transparent and allow light to pass through. Conversely, when reduced, the electrochromic layer ECL may display a color and block light.

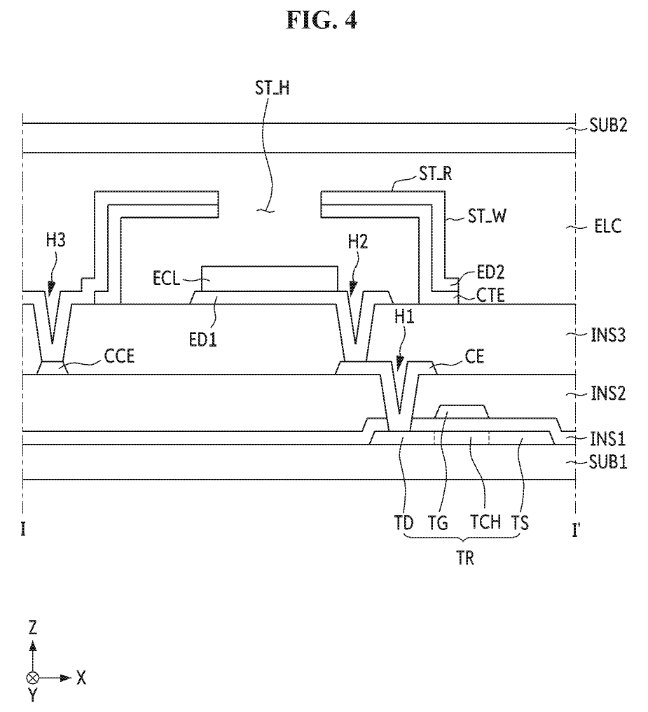

The structural portion ST may include a counter layer CTE and a common electrode ED2 as depicted in FIG. 4. The structural portion ST may overlap a portion of the electrochromic layer ECL in a third direction (e.g., the Z-axis direction). The outer circumference of the structural portion ST may be positioned outside the electrochromic layer ECL. The inner circumference of the structural portion ST may be positioned on the electrochromic layer ECL.

One electrochromic layer ECL may be arranged adjacent to another electrochromic layer ECL in the first direction. A structural portion ST for one electrochromic layer ECL may be arranged adjacent to another structural portion ST for another electrochromic layer ECL in the first direction. Here, these structural portions ST may be spaced apart from each other.

FIG. 2 illustrates an example where in plan view, an electrochromic layer ECL is rectangular and a structural portion ST is a rectangular frame, but the present disclosure is not limited thereto. The planar shape of the electrochromic layer ECL may be modified into various shapes, such as a circle, ellipse, rhombus, or convex polygon. The outer circumference of the structural portion ST may follow the planar shape of the electrochromic layer ECL. The inner circumference of the structural portion ST may or may not follow the planar shape of the electrochromic layer ECL. Alternatively, the planar shape of the electrochromic layer ECL may be rectangular, the outer circumference of the structural portion ST may be rectangular, and the inner circumference of the structural portion ST may be circular.

FIG. 3 is an enlarged perspective view of a pixel in FIG. 2.

Referring to FIG. 3, a pixel PX may include a pixel electrode ED1, an electrochromic layer ECL, and a structural portion ST.

The pixel electrode ED1 may be positioned on a third insulating layer INS3. The electrochromic layer ECL may be positioned on the pixel electrode ED1. The structural portion ST may be positioned around the pixel electrode ED1 and the electrochromic layer ECL. The structural portion ST may be spaced apart from the pixel electrode ED1 and the electrochromic layer ECL.

The structural portion ST may include a side portion ST_W positioned on at least one side surface of the electrochromic layer ECL, and a top portion ST_R connected to the side portion ST_W. As shown in FIG. 4, the structural portion ST may include a counter layer CTE and a common electrode ED2.

The side portion ST_W may be positioned around the pixel electrode ED1 and the electrochromic layer ECL (e.g., in plan view). The side portion ST_W may be spaced apart from the pixel electrode ED1 and the electrochromic layer ECL.

For example, the side portion ST_W may include a first side surface, a second side surface facing the first side surface, a third side surface connecting one side of the first side surface and one side of the second side surface, and a fourth side surface connecting the other side of the first side surface and the other side of the second side surface.

The electrochromic layer ECL may include a top surface, a bottom surface facing the top surface, a first surface connecting one side of the top surface and one side of the bottom surface, a second surface facing the first surface, a third surface connecting one side of the first surface and one side of the second surface, and a fourth surface connecting the other side of the first surface and the other side of the second surface.

The first side surface of the side portion ST_W may be positioned on the first surface of the electrochromic layer ECL. The first side surface of the side portion ST_W may be spaced apart from the first surface of the electrochromic layer ECL. The first side surface of the side portion ST_W and the first surface of the electrochromic layer ECL may be substantially parallel to each other. The extension direction of the first side surface of the side portion ST_W may be the same as that of the first surface of the electrochromic layer ECL. For example, the first side surface of the side portion ST_W may extend in the first direction. In addition, the first side surface of the side portion ST_W may include a first protrusion formed on its lower side. For example, the first protrusion may be a portion protruding in a direction opposite to the second direction.

The second side surface of the side portion ST_W may be positioned on the second surface of the electrochromic layer ECL. The second side surface of the side portion ST_W may be spaced apart from the second surface of the electrochromic layer ECL. The second side surface of the side portion ST_W may be arranged parallel to the second surface of the electrochromic layer ECL (as used herein, “parallel” may mean “substantially parallel”). The extension direction of the second side surface of the side portion ST_W may be the same as that of the second surface of the electrochromic layer ECL. For example, the second side surface of the side portion ST_W may extend in the first direction. In addition, the second side surface of the side portion ST_W may include a second protrusion formed on its lower side. For example, the second protrusion may be a portion protruding in the second direction.

The third side surface of the side portion ST_W may be positioned on the third surface of the electrochromic layer ECL. The third side surface of the side portion ST_W may be spaced apart from the third surface of the electrochromic layer ECL. The third side surface of the side portion ST_W may be arranged parallel to the third surface of the electrochromic layer ECL. The extension direction of the third side surface of the side portion ST_W may be the same as that of the third surface of the electrochromic layer ECL. For example, the third side surface of the side portion ST_W may extend in the second direction. In addition, the third side surface of the side portion ST_W may include a third protrusion formed on its lower side. For example, the third protrusion may be a portion protruding in the first direction.

The fourth side surface of the side portion ST_W may be positioned on the fourth surface of the electrochromic layer ECL. The fourth side surface of the side portion ST_W may be spaced apart from the fourth surface of the electrochromic layer ECL. The fourth side surface of the side portion ST_W may be arranged parallel to the fourth surface of the electrochromic layer ECL. The extension direction of the fourth side surface of the side portion ST_W may be the same as that of the fourth surface of the electrochromic layer ECL. For example, the fourth side surface of the side portion ST_W may extend in the second direction. In addition, the fourth side may include a fourth protrusion formed on its lower side. For example, the fourth protrusion may be a portion protruding in a direction opposite to the first direction.

The top portion ST_R may overlap portion of the pixel electrode ED1 and the electrochromic layer ECL in the third direction. The top portion ST_R may include, or define, an opening ST_H that overlaps the electrochromic layer ECL in the third direction. The outer circumference of the top portion ST_R may be positioned outside the electrochromic layer ECL in the third direction. The inner circumference of the top portion ST_R may be positioned inside the electrochromic layer ECL in the third direction.

FIG. 4 is a cross-sectional view, taken along the line I-I′ of FIG. 2, of an example of the display panel 100.

Referring to FIG. 4, the display panel 100 may include a first substrate SUB1, a transistor TR, a first insulating layer INS1, a second insulating layer INS2, an anode connection electrode CE, a cathode connection electrode CCE, a third insulating layer INS3, a pixel electrode ED1, an electrochromic layer ECL, a counter layer CTE, a common electrode ED2, an electrolyte layer ELC, and a second substrate SUB2.

The first and second substrates SUB1 and SUB2 may include a transparent material capable of passing light therethrough. For example, the first and second substrates SUB1 and SUB2 may include glass or plastic.

More than one transistor TR may be positioned on one surface of the first substrate SUB1. The transistor TR may include a gate electrode TG, a source electrode TS, a drain electrode TD, and a channel TCH. The channel TCH may be a region overlapping the gate electrode TG in the thickness direction of the first substrate SUB1. The source electrode TS may be positioned at one side of the channel TCH, and the drain electrode TD may be a region that does not overlap the gate electrode TG in the third direction (e.g., a region that is spaced from the gate electrode TG in plan view). The source electrode TS and the drain electrode TD may be regions having conductivity due to ion doping in a silicon semiconductor or an oxide semiconductor.

The first insulating layer INS1 may be positioned on one surface of each of the first substrate SUB1, source electrode TS, channel TCH, and drain electrode TD. The first insulating layer INS1 may include an inorganic film, for example, a silicon nitride layer, a silicon oxynitride layer, a silicon oxide layer, a titanium oxide layer, or an aluminum oxide layer.

A gate electrode TG and a second insulating layer INS2 may be positioned on one surface of the first insulating layer INS1. The second insulating layer INS2 may planarize a step caused by the transistor TR. The second insulating layer INS2 may include an organic film, such as acryl resin, epoxy resin, phenolic resin, polyamide resin, or polyimide resin.

An anode connection electrode CE and a cathode connection electrode CCE may be positioned on one surface of the second insulating layer INS2. The anode connection electrode CE may be connected to the source electrode TS or the drain electrode TD of the transistor TR through a first hole H1 that penetrates the first and second insulating layers INS1 and INS2.

A third insulating layer INS3 may be positioned on one surface of the second insulating layer INS2. The third insulating layer INS3 may include an organic film, such as acryl resin, epoxy resin, phenolic resin, polyamide resin, or polyimide resin.

The pixel electrode ED1, the common electrode ED2, and the counter layer CTE may be positioned on one surface of the third insulating layer INS3. The pixel electrode ED1 may be connected to the anode connection electrode CE through a second hole H2 that penetrates the third insulating layer INS3. The pixel electrode ED1 may be a transparent electrode that allows light to pass through. For example, the pixel electrode ED1 may include a transparent conductive oxide (TCO), such as ITO or IZO, or a semi-transmissive conductive material, such as magnesium (Mg), silver (Ag), or an alloy thereof.

The counter layer CTE corresponds to a layer that assists the electrochromic layer ECL to smoothly undergo a redox reaction. The counter layer CTE may absorb a corresponding color when an oxidation reaction occurs, thereby exhibiting the corresponding color, and may include a counter material that becomes transparent by a reduction reaction. Accordingly, the counter layer CTE may cause the electrochromic layer ECL to change color more quickly and allow the pixel PX to appear more vivid in the corresponding color. The counter material may be NiO, N, N, N′, N′-tetramethyl-1,4-phenylenediamine (TMPD), 3,3′,5,5′-tetramethylbenzidine (TMB), N, N, N′, N′-tetramethylbenzidine (NTMB), or 3,3′-diaminobenzidine (DAB).

The counter layer CTE may include a transparent electrode and an ion storage layer. The transparent electrode may include a TCO, such as ITO or IZO, or a semi-transmissive conductive material, such as Mg, Ag, or an alloy thereof. The ion storage layer may include a counter material, such as NiO. The transparent electrode may be positioned on the ion storage layer. The distance between the transparent electrode and the electrochromic layer ECL may be greater than the distance between the ion storage layer and the electrochromic layer ECL. The transparent electrode and the ion storage layer may contact each other.

In some embodiments, an inorganic layer or an organic layer may be positioned between the transparent electrode and the ion storage layer. In this case, the ion storage layer may be connected to the transparent electrode through a contact hole that penetrates the inorganic layer or the organic layer. The inorganic layer or organic layer positioned between the transparent electrode and the ion storage layer may protect the transparent electrode or form and planarize a step. Through this, the stability of the counter layer CTE may be enhanced, and the distance between the transparent electrode and the electrochromic layer ECL may be optimized.

The counter layer CTE may be included in the structural portion ST. The counter layer CTE may form a lower portion of the structural portion ST. A side portion ST_W of the counter layer CTE may contact the third insulating layer INS3. The side portion ST_W of the counter layer CTE may include a protruding portion protruding in a direction away from the electrochromic layer ECL. A top portion ST_R of the counter layer CTE may be connected to the side portion ST_W of the counter layer CTE. The top portion ST_R of the counter layer CTE may include, or define, an opening ST_H that overlaps the electrochromic layer ECL in the third direction.

The common electrode ED2 may be connected to the cathode connection electrode CCE through a third hole H3 that penetrates the third insulating layer INS3. The common electrode ED2 may include a TCO, such as ITO or IZO, or a semi-transmissive conductive material, such as Mg, Ag, or an alloy thereof.

The common electrode ED2 may be positioned on the counter layer CTE. A lower surface of the common electrode ED2 may contact an upper surface of the counter layer CTE. The common electrode ED2 may be included in the structural portion ST. The common electrode ED2 may form an upper portion of the structural portion ST. A side portion ST_W of the common electrode ED2 may be positioned on the side portion ST_W of the counter layer CTE. A top portion ST_R of the common electrode ED2 may be positioned on the top portion ST_R of the counter layer CTE. The top portion ST_R of the common electrode ED2 may be connected to the side portion ST_W of the common electrode ED2. The top portion ST_R of the common electrode ED2 may include, or define, an opening ST_H that overlaps the electrochromic layer ECL in the third direction.

The electrochromic layer ECL may be positioned on one surface of the pixel electrode ED1. The electrochromic layer ECL may include an electrochromic inorganic material. The electrochromic inorganic material may be an inorganic material that absorbs a corresponding color by a reduction reaction to exhibit the corresponding color and becomes transparent by an oxidation reaction. For example, the electrochromic inorganic material may include at least one of WO₃, NiOₓH_{y}, Nb₂O₅, V₂O₅, TiO₂, or MoO₃. To enhance the light-blocking function of the electrochromic layer ECL, the electrochromic layer ECL may include various electrochromic inorganic materials that exhibit a variety of colors through a reduction reaction.

The electrolyte layer ELC may be positioned between the electrochromic layer ECL and the counter layer CTE and around the common electrode ED2. The electrolyte layer ELC may include an electrolyte, a polymer, and a UV initiator. The electrolyte may be lithium perchlorate, t-butylammonium perchlorate, t-butylammonium-t-fluoroborate, or tetrabutylammonium trifluoromethanesulfonate. The polymer may be an acrylate-, polyester-, or epoxy-based polymer. The UV initiator may be a benzoin ether-based compound or an amine-based compound. The electrolyte layer ELC may be applied in a viscous liquid state and then formed by UV curing. The electrolyte layer ELC may provide cations and anions to enable redox reactions of the electrochromic layer ECL and the counter layer CTE.

For example, when a first driving voltage applied to the pixel electrode ED1 is a negative voltage and a second driving voltage applied to the common electrode ED2 is a positive voltage, a reduction reaction may occur in the electrochromic layer ECL, and an oxidation reaction may occur in the counter layer CTE. Here, the negative voltage may be a voltage less than about 0 V, and the positive voltage may be a voltage greater than about 0 V. In this case, because the electrochromic layer ECL takes on a color (e.g., a predetermined color) by the reduction reaction, it may block most of the incident light. Accordingly, the pixel PX of the electrochromic layer ECL may implement a light-blocking mode that blocks the incident light. For example, the pixel PX in the light-blocking mode may display a character.

On the other hand, when the first driving voltage applied to the pixel electrode ED1 is a positive voltage and the second driving voltage applied to the common electrode ED2 is a negative voltage, an oxidation reaction may occur in the electrochromic layer ECL, and a reduction reaction may occur in the counter layer CTE. In this case, the electrochromic layer ECL may become transparent due to the oxidation reaction and may transmit most of the incident light. Accordingly, the pixel PX of the electrochromic layer ECL may implement a light-transmitting mode. For example, the pixel PX in the light-transmitting mode may display a background.

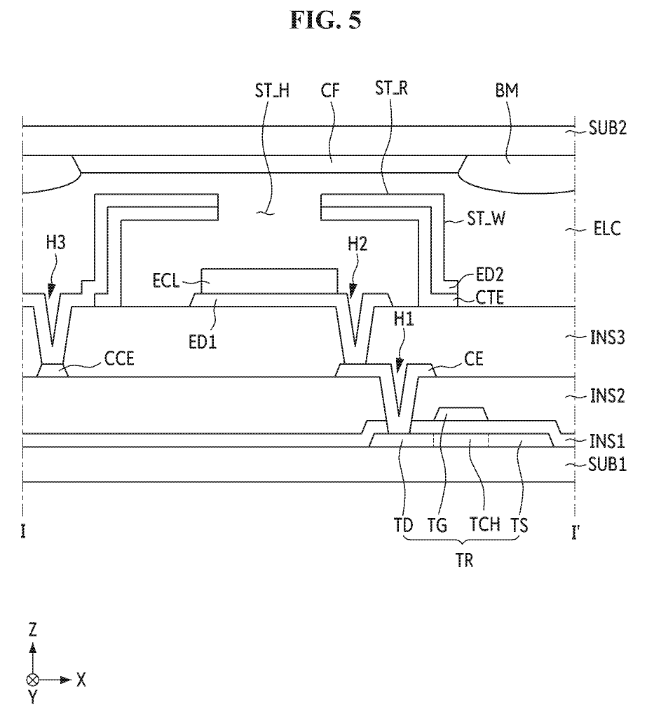

FIG. 5 is a cross-sectional view, taken along the line I-I′ of FIG. 2, of another example of the display panel 100. In the following description, any redundant descriptions will be omitted, and differences will be primarily described.

Referring to FIG. 5, the display panel 100 may include a first substrate SUB1, a transistor TR, a first insulating layer INS1, a second insulating layer INS2, an anode connection electrode CE, a cathode connection electrode CCE, a third insulating layer INS3, a pixel electrode ED1, an electrochromic layer ECL, a counter layer CTE, a common electrode ED2, an electrolyte layer ELC, a color filter CF, a black matrix BM, and a second substrate SUB2.

Compared to its counterpart of FIG. 4, the display panel 100 of FIG. 5 may further include the color filter CF and the black matrix BM.

The color filter CF may be positioned on one surface of the second substrate SUB2. The color filter CF may contact a lower surface of the second substrate SUB2. The color filter CF may overlap the pixel electrode ED1, the electrochromic layer ECL, the counter layer CTE, and the common electrode ED2 in the third direction. The color filter CF may transmit light of a corresponding wavelength when light including multiple wavelength bands is incident. The color of the light transmitted by the color filter CF may be the same as or different from the electrochromic color of the electrochromic layer ECL.

The black matrix BM may be positioned around the color filter CF. The black matrix BM may be formed using a material that absorbs visible light, for example, a resin material containing a metal material, a pigment, or a dye. The black matrix BM may reduce or prevent color mixing between pixels PX. The black matrix BM may overlap the transistor TR in the third direction. The black matrix BM may be spaced apart from the pixel electrode ED1 and the electrochromic layer ECL in the third direction.

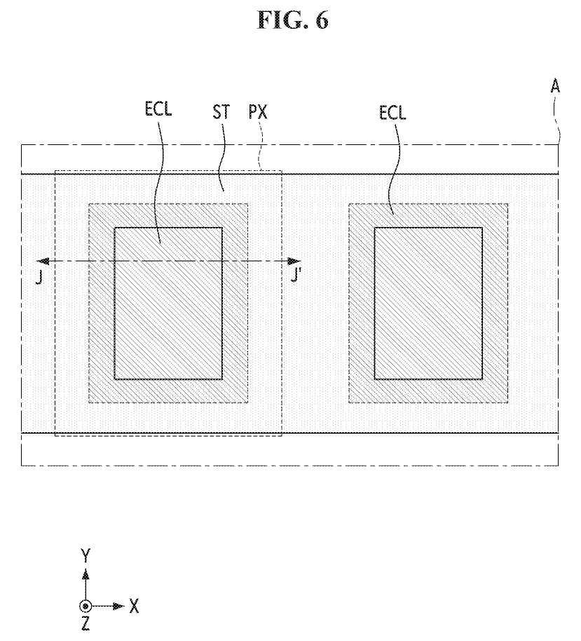

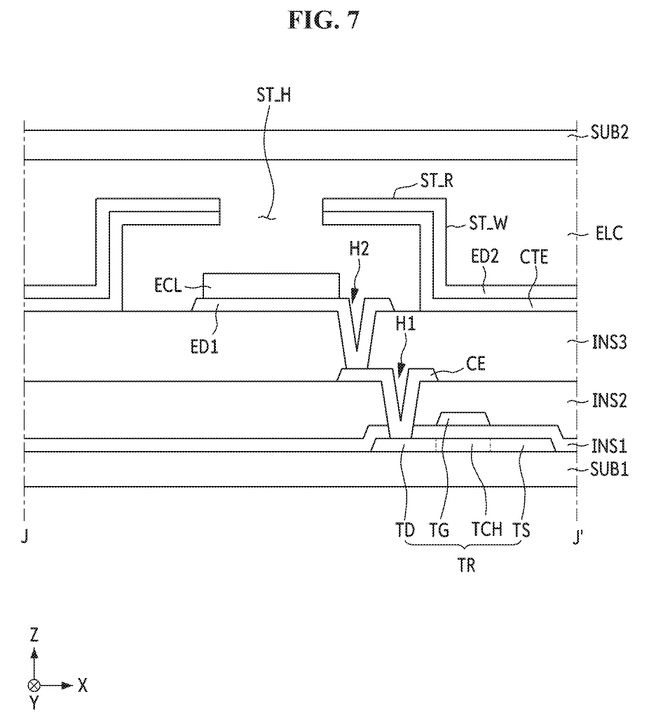

FIG. 6 is an enlarged layout view of another example of region A in FIG. 1. FIG. 7 is a cross-sectional view taken along the line J-J′ in FIG. 6. In the following description, any redundant descriptions will be omitted, and differences will be primarily described.

Referring to FIG. 6, a structural portion ST for one pixel PX may be connected to a structural portion ST for an adjacent pixel PX. For each pixel PX, the structural portion ST may include, or define, an opening ST_H overlapping an electrochromic layer ECL in the third direction. The planar shape of the opening ST_H may follow or may not follow the planar shape of the electrochromic layer ECL. FIG. 6 illustrates an example in which the electrochromic layer ECL and the opening ST_H of each pixel PX both have a rectangular planar shape.

Referring to FIG. 7, the display panel 100 may include a first substrate SUB1, a transistor TR, a first insulating layer INS1, a second insulating layer INS2, an anode connection electrode CE, a cathode connection electrode CCE, a third insulating layer INS3, a pixel electrode ED1, an electrochromic layer ECL, a counter layer CTE, a common electrode ED2, an electrolyte layer ELC, and a second substrate SUB2.

Compared to FIG. 4, a side portion ST_W of the counter layer CTE arranged around one electrochromic layer ECL may be connected to a side portion ST_W of the counter layer CTE arranged around an adjacent electrochromic layer ECL. Similarly, a side portion ST_W of the common electrode ED2 arranged around one electrochromic layer ECL, on the counter layer CTE, may be connected to a side portion ST_W of the common electrode ED2 arranged around an adjacent electrochromic layer ECL and on the counter layer CTE.

In this case, the common electrode ED2 may extend to the non-display area NDA. The third hole H3 formed for each pixel PX in FIG. 4 may be omitted in FIG. 7. The common electrode ED2 may receive a second driving voltage from the non-display area NDA.

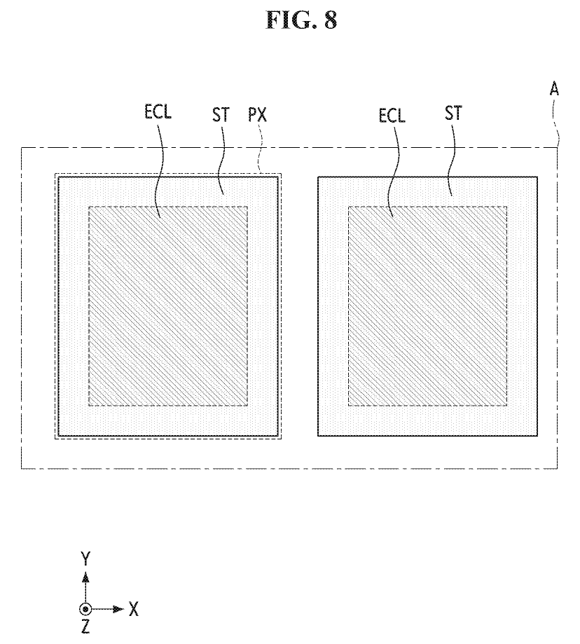

FIG. 8 is an enlarged layout view illustrating another example of region A in FIG. 1. In the following description, any redundant descriptions will be omitted, and differences will be primarily described.

Referring to FIG. 8, the display panel 100 may include a plurality of pixels PX. Each pixel PX may include an electrochromic layer ECL and a structural portion ST.

FIG. 8 illustrates an example in which the electrochromic layer ECL and the structural portion ST are both rectangular in plan view, but the planar shapes of the electrochromic layer ECL and the structural portion ST may be modified.

Unlike its counterpart in FIG. 2, which includes an opening ST_H that overlaps the electrochromic layer ECL in the third direction, the structural portion ST in FIG. 8 may not include such an opening ST_H. Accordingly, while the structural portion ST in FIG. 2 exposes a portion of the electrochromic layer ECL in the third direction, the electrochromic layer ECL in FIG. 8 may not be exposed in the third direction.

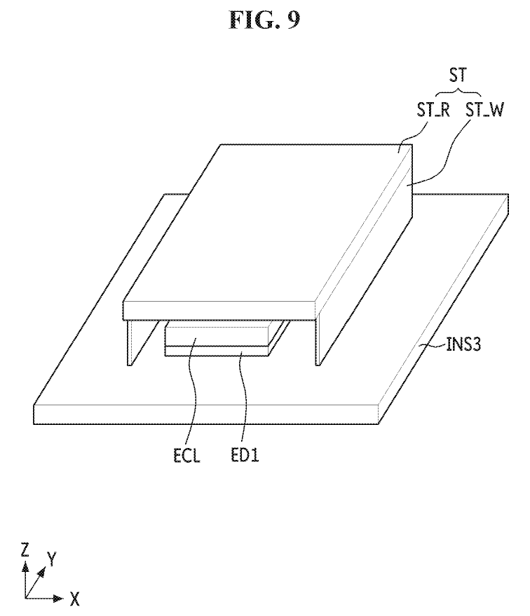

FIG. 9 is an enlarged perspective view of an example of a pixel in FIG. 8. In the following description, any redundant descriptions will be omitted, and differences will be primarily described.

Referring to FIG. 9, a structural portion ST including a counter layer CTE and a common electrode ED2 may have a top portion ST_R and a side portion ST_W.

The side portion ST_W may include a first side surface extending in the second direction, and a second side surface opposite to the first side surface and extending in the second direction.

The electrochromic layer ECL may include a first surface extending in the second direction, a second surface opposite to the first surface and extending in the second direction, a third surface connecting one side of the first surface and one side of the second surface, and a fourth surface connecting the other side of the first surface and the other side of the second surface.

The first side of the side portion ST_W may be spaced apart from the electrochromic layer ECL, on the first surface of the electrochromic layer ECL. The second side of the side portion ST_W may be spaced apart from the electrochromic layer ECL, on the second surface of the electrochromic layer ECL. The side portion ST_W may not be positioned on, or may be omitted in regions corresponding to, the third and fourth surfaces of the electrochromic layer ECL. The side portion ST_W may include, or define, a first opening that exposes the third surface of the electrochromic layer ECL. The side portion ST_W may include, or define, a second opening that exposes the fourth surface of the electrochromic layer ECL. The first and second openings may be formed from the lower side of the side portion ST_W to the lower side of the top portion ST_R. Accordingly, when the electrolyte layer ELC is filled, an air layer that introduced between the counter layer CTE and the electrochromic layer ECL may suitably escape from the pixel PX through the first and second openings. Therefore, the amount of air contained in the electrolyte layer ELC may be reduced, and performance degradation of the electrolyte layer ELC due to the air may be reduced or minimized.

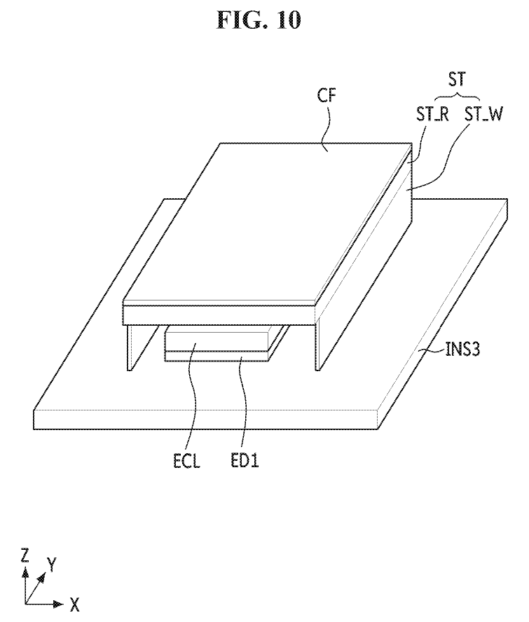

FIG. 10 is an enlarged perspective view of another example of the pixel in FIG. 8. In the following description, any redundant descriptions will be omitted, and differences will be primarily described.

Referring to FIG. 10, compared to FIG. 9, a color filter CF may be positioned on or above the top portion ST_R of the structural portion ST. The color filter CF may transmit light of a corresponding wavelength when light including multiple wavelength bands is incident. The color of the light transmitted by the color filter CF may be the same as or different from the electrochromic color of the electrochromic layer ECL.

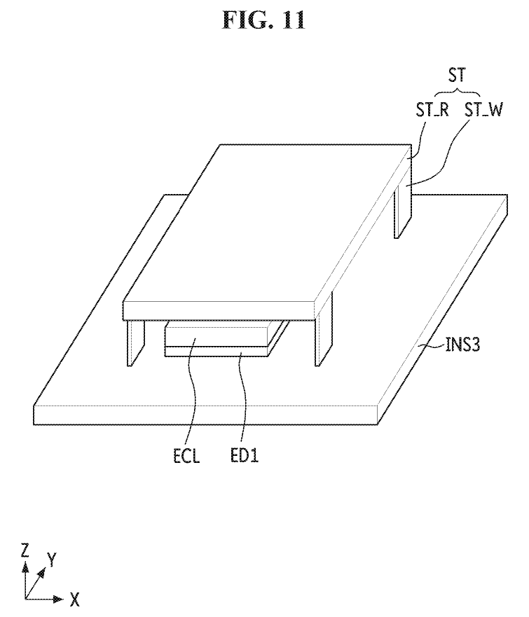

FIG. 11 is an enlarged perspective view illustrating yet another example of the pixel in FIG. 8. In the following description, any redundant descriptions will be omitted, and differences will be primarily described.

Referring to FIG. 11, the structural portion ST including the counter layer CTE and the common electrode ED2 may have the top portion ST_R and the side portion ST_W.

The side portion ST_W may include a first side surface extending in the second direction, and a second side surface opposite to the first side surface and extending in the second direction.

The electrochromic layer ECL may include a first surface extending in the second direction, a second surface opposite to the first surface and extending in the second direction, a third surface connecting one side of the first surface and one side of the second surface, and a fourth surface connecting the other side of the first surface and the other side of the second surface.

The first side of the side portion ST_W may be spaced apart from the first surface of the electrochromic layer ECL. The second side of the side portion ST_W may be spaced apart from the second surface of the electrochromic layer ECL. The side portion ST_W may not be positioned on, or may be omitted from regions corresponding to, the third and fourth surfaces of the electrochromic layer ECL.

The side portion ST_W may include, or define, a first opening that exposes the third surface of the electrochromic layer ECL. The side portion ST_W may also include, or define, a second opening that exposes the fourth surface of the electrochromic layer ECL. The first and second openings may be formed from, or may extend from, the lower side of the side portion ST_W to the lower side of the top portion ST_R.

The side portion ST_W may further include a third opening that exposes a portion of the electrochromic layer ECL at the first surface of the electrochromic layer ECL. The third opening may be formed on the first side surface of the side portion ST_W. The side portion ST_W may further include a fourth opening that exposes a portion of the electrochromic layer ECL at the second surface of the electrochromic layer ECL. The fourth opening may be formed on the second side surface of the side portion ST_W. The third and fourth openings may be formed from the lower side of the side portion ST_W to the lower side of the top portion ST_R.

Accordingly, when the electrolyte layer ELC is filled, an air layer introduced between the counter layer CTE and the electrochromic layer ECL may suitably escape from the pixel PX through the first through fourth openings. Therefore, the amount of air contained in the electrolyte layer ELC may be reduced, and performance degradation of the electrolyte layer ELC due to the air may be reduced or minimized.

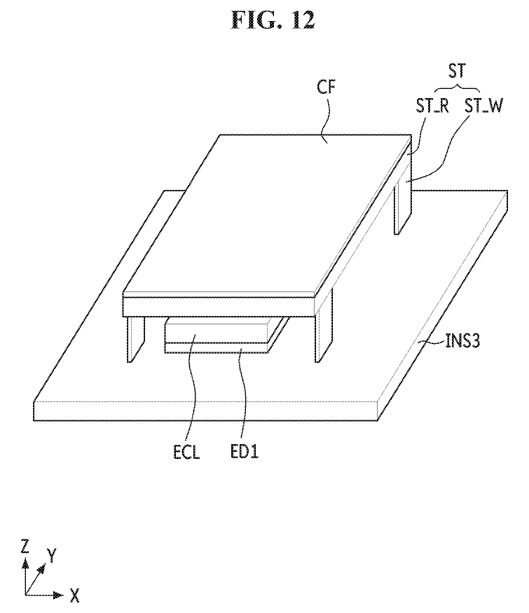

FIG. 12 is an enlarged perspective view illustrating another example of the pixel in FIG. 8. In the following description, any redundant descriptions will be omitted, and differences will be primarily described.

Referring to FIG. 12, compared to FIG. 11, a color filter CF may be positioned on or above a top portion ST_R of the structural portion ST. The color filter CF may transmit light of a corresponding wavelength when light in which multiple wavelength bands are mixed is incident. The color of the light transmitted by the color filter CF may be the same as or different from the electrochromic color of the electrochromic layer ECL.

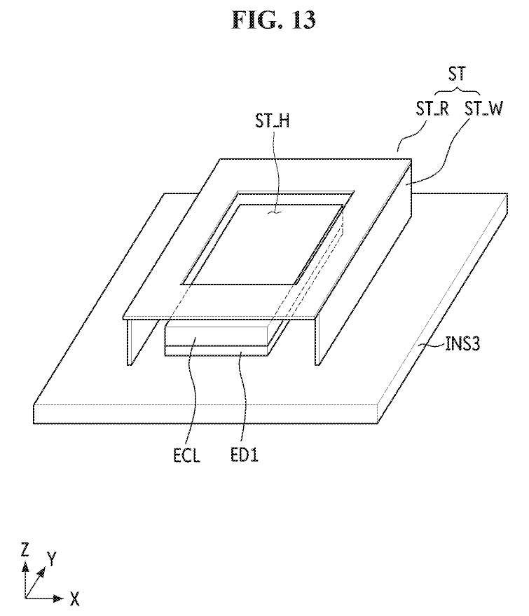

FIG. 13 is an enlarged perspective view of the pixel in FIG. 2. In the following description, any redundant descriptions will be omitted, and differences will be primarily described.

Referring to FIG. 13, a top opening ST_H may be formed in, or defined by, the top portion ST_R of the structural portion ST. The side portion ST_W of the structural portion ST may include a first side surface extending in the second direction, and a second side surface opposite to the first side surface and extending in the second direction.

The electrochromic layer ECL may include a first surface extending in the second direction, a second surface opposite to the first surface and extending in the second direction, a third surface connecting one side of the first surface and one side of the second surface, and a fourth surface connecting the other side of the first surface and the other side of the second surface.

The first side surface of the side portion ST_W may be spaced apart from the first surface of the electrochromic layer ECL. The second side surface of the side portion ST_W may be spaced apart from the second surface of the electrochromic layer ECL. The side portion ST_W may not be positioned on, or may be omitted from positions corresponding to, the third and fourth surfaces of the electrochromic layer ECL. The side portion ST_W may include, or define, a first opening that exposes the third surface of the electrochromic layer ECL. The side portion ST_W may include, or define, a second opening that exposes the fourth surface of the electrochromic layer ECL. The first and second openings may be formed from the lower side of the side portion ST_W to the lower side of the top portion ST_R. Accordingly, when the electrolyte layer ELC is filled, an air layer introduced between the counter layer CTE and the electrochromic layer ECL may suitably escape from the pixel PX through the top opening ST_H, the first opening, and the second opening. Therefore, the amount of air contained in the electrolyte layer ELC may be reduced, and performance degradation of the electrolyte layer ELC due to the air may be reduced or minimized.

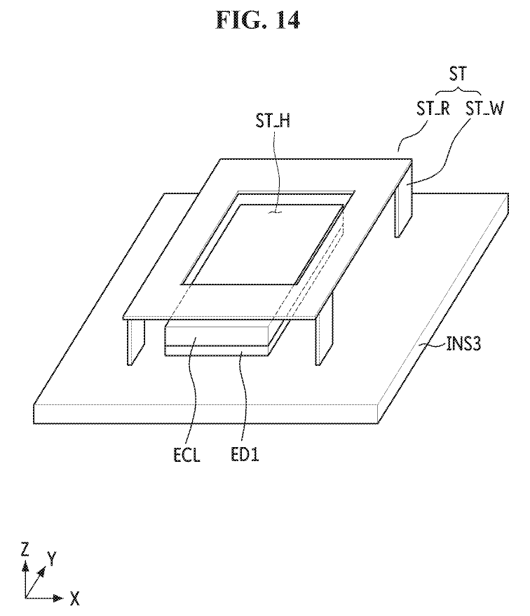

FIG. 14 is an enlarged perspective view illustrating another example of the pixel in FIG. 2. In the following description, any redundant descriptions will be omitted, and differences will be primarily described.

Referring to FIG. 14, the structural portion ST including the counter layer CTE and the common electrode ED2 may have a top portion ST_R and a side portion ST_W. A top opening ST_H may be formed in, or defined by, the top portion ST_R of the structural portion ST. The side portion ST_W of the structural portion ST may include a first side surface extending in the second direction, and a second side surface opposite to the first side surface and extending in the second direction.

The electrochromic layer ECL may include a first surface extending in the second direction, a second surface opposite to the first surface and extending in the second direction, a third surface connecting one side of the first surface and one side of the second surface, and a fourth surface connecting the other side of the first surface and the other side of the second surface.

The first side surface of the side portion ST_W may be spaced apart from the first surface of the electrochromic layer ECL. The second side surface of the side portion ST_W may be spaced apart from the second surface of the electrochromic layer ECL. The side portion ST_W may not be positioned on, or may be omitted from positions corresponding to, the third and fourth surfaces of the electrochromic layer ECL.

The side portion ST_W may include, or define, a first opening that exposes the third surface of the electrochromic layer ECL. The side portion ST_W may include, or define, a second opening that exposes the fourth surface of the electrochromic layer ECL. The first and second openings may be formed from the lower side of the side portion ST_W to the lower side of the top portion ST_R.

The side portion ST_W may further include a third opening that exposes a portion of the first surface of the electrochromic layer ECL. The third opening may be formed in, or defined by, the first side surface. The side portion ST_W may further include a fourth opening that exposes a portion of the fourth surface of the electrochromic layer ECL. The fourth opening may be formed in, or defined by, the second side surface. The third and fourth openings may be formed from the lower side of the side portion ST_W to the lower side of the top portion ST_R.

Accordingly, when the electrolyte layer ELC is filled, an air layer introduced between the counter layer CTE and the electrochromic layer ECL may suitably escape from the pixel PX through the top opening ST_H and the first through fourth openings. Therefore, the amount of air contained in the electrolyte layer ELC may be reduced, and performance degradation of the electrolyte layer ELC due to the air may be reduced or minimized.

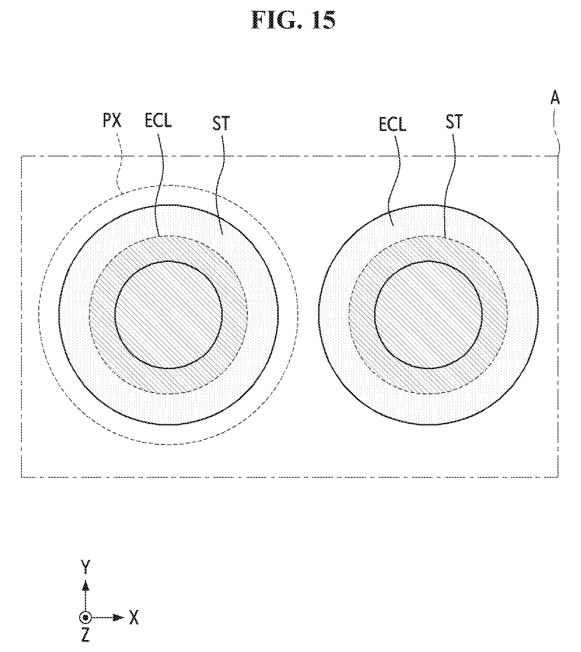

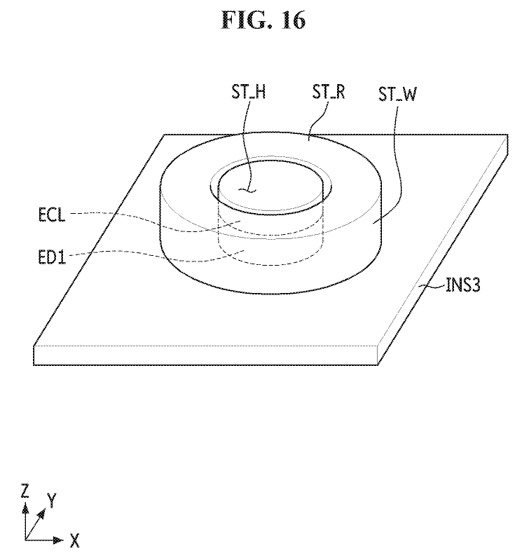

FIG. 15 is an enlarged layout view illustrating another example of region A in FIG. 1. FIG. 16 is an enlarged perspective view illustrating one example of a pixel in FIG. 15. In the following description, any redundant descriptions will be omitted, and differences will be primarily described.

Referring to FIG. 15, each pixel PX may include an electrochromic layer ECL and a structural portion ST. For example, in plan view, the electrochromic layer ECL may be circular, and the structural portion ST may have a ring shape. However, the embodiments are not limited to this example, and the planar shapes of the electrochromic layer ECL and the structural portion ST may be modified.

The structural portion ST may include, or define, an opening ST_H. The opening ST_H may expose a portion of the electrochromic layer ECL in the third direction. The structural portion ST may overlap a portion of the electrochromic layer ECL in the third direction. The outer circumference of the structural portion ST may be positioned outside the electrochromic layer ECL. The inner circumference of the structural portion ST may be positioned on the electrochromic layer ECL.

One electrochromic layer ECL may be positioned adjacent to another electrochromic layer ECL in the first direction. A structural portion ST for one electrochromic layer ECL may be positioned adjacent to a structural portion ST for another electrochromic layer ECL in the first direction. These structural portions ST may be spaced apart from each other.

Referring to FIG. 16, a pixel PX may include a pixel electrode ED1, an electrochromic layer ECL, and a structural portion ST.

The pixel electrode ED1 may be positioned on or above an insulating layer INS3. The electrochromic layer ECL may be positioned on or above the pixel electrode ED1. The structural portion ST may be positioned around (e.g., in plan view) the pixel electrode ED1 and the electrochromic layer ECL. The structural portion ST may be spaced apart from the pixel electrode ED1 and the electrochromic layer ECL.

The structural portion ST may include a side portion ST_W positioned on at least one side surface of the electrochromic layer ECL, and a top portion ST_R connected to the side portion ST_W. The structural portion ST may include a counter layer CTE and a common electrode ED2.

The side portion ST_W may be positioned around the pixel electrode ED1 and the electrochromic layer ECL. The side portion ST_W may be spaced apart from the pixel electrode ED1 and the electrochromic layer ECL.

For example, the electrochromic layer ECL may have a circular planar shape. The planar shape of the top portion ST_R may follow the planar shape of the electrochromic layer ECL. In this case, the planar shape of an opening ST_H formed in the top portion ST_R may also follow the planar shape of the electrochromic layer ECL. The side portion ST_W may be formed as a curved surface along the side surface of the electrochromic layer ECL.

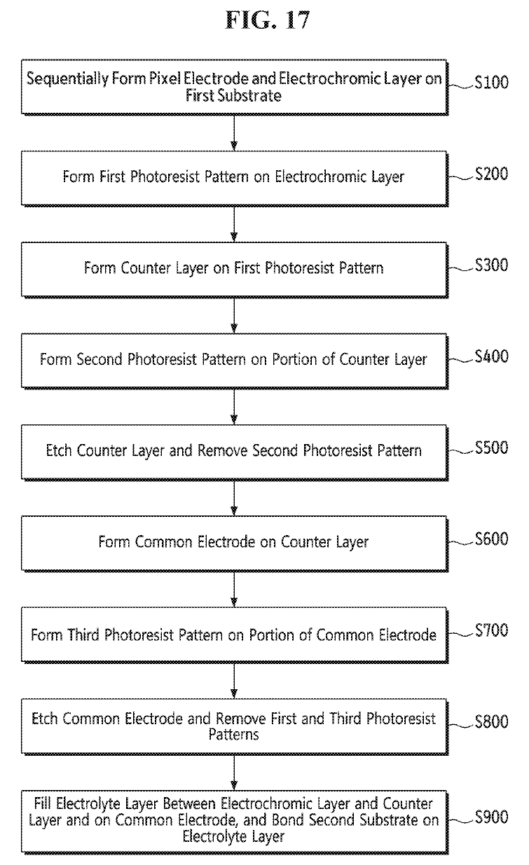

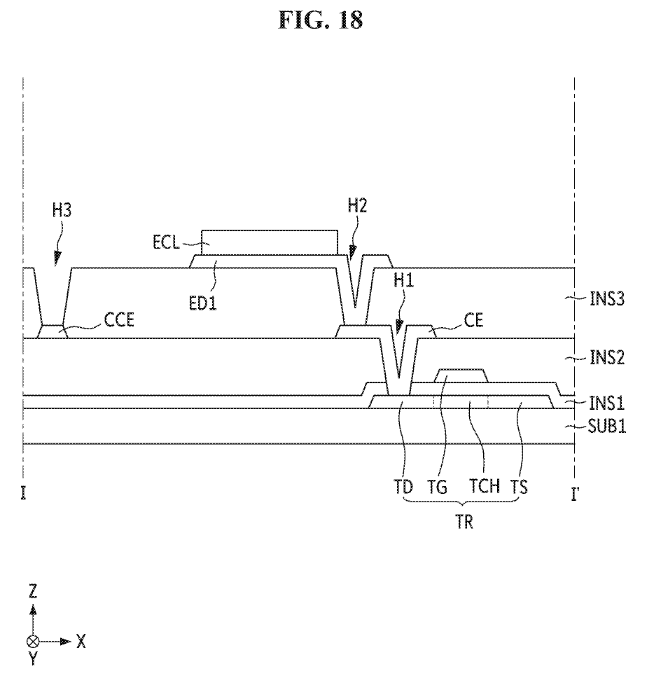

FIG. 17 is a flowchart illustrating a method for manufacturing a display device according to some embodiments of the present disclosure. FIGS. 18-27 are diagrams for explaining the method of FIG. 17. In the following description, any redundant descriptions will be omitted, and differences will be primarily described.

Referring to FIG. 17, a pixel electrode ED1 and an electrochromic layer ECL are sequentially formed on a first substrate SUB1 (S100).

Referring to FIG. 18, a drain electrode TD, a channel TCH, and a source electrode TS of a transistor TR may be formed on the first substrate SUB1 (as used herein, “formed on” may mean “above”). A first insulating layer INS1 may be formed on the drain electrode TD, the channel TCH, and the source electrode TS of the transistor TR, and a gate electrode TG may be formed on the first insulating layer INS1. A second insulating layer INS2 may be formed on the gate electrode TG and the first insulating layer INS1, and an anode connection electrode CE and a cathode connection electrode CCE may be formed on the second insulating layer INS2. A third insulating layer INS3 may be formed on the second insulating layer INS2, and second and third holes H2 and H3 may be formed to penetrate the third insulating layer INS3. A pixel electrode ED1 may be formed on the third insulating layer INS3, and the electrochromic layer ECL may be formed on the pixel electrode ED1.

Thereafter, a first photoresist pattern PR1 is formed on the electrochromic layer ECL (S200).

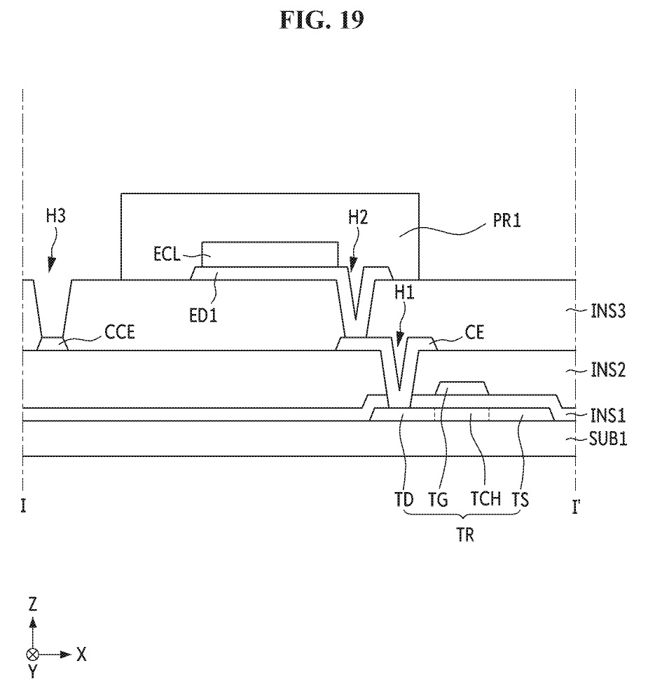

Referring to FIG. 19, the first photoresist pattern PR1 may be formed on the electrochromic layer ECL. The first photoresist pattern PR1 may cover the second hole H2, and may not be positioned on the third hole H3.

Thereafter, a counter layer CTE is formed on the first photoresist pattern PR1 (S300).

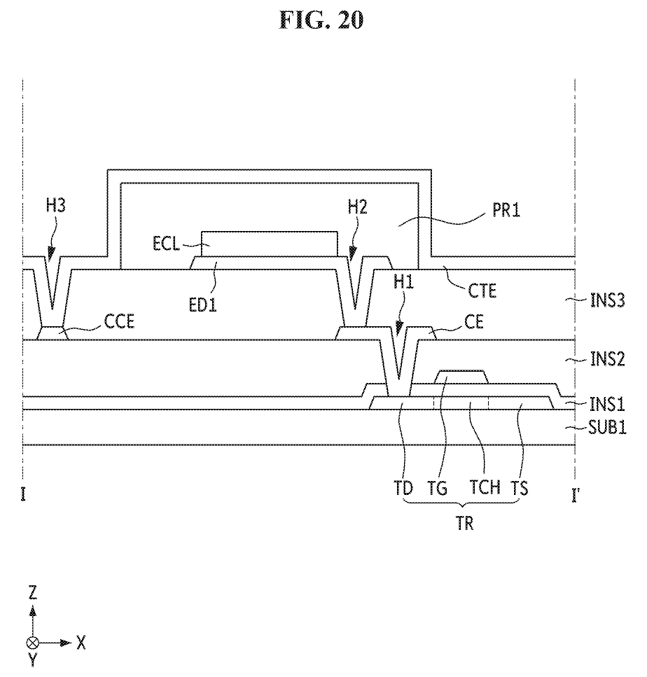

Referring to FIG. 20, the counter layer CTE may be formed on the first photoresist pattern PR1. The counter layer CTE may also be positioned inside the third hole H3.

Thereafter, a second photoresist pattern PR2 is formed on a portion of the counter layer CTE (S400).

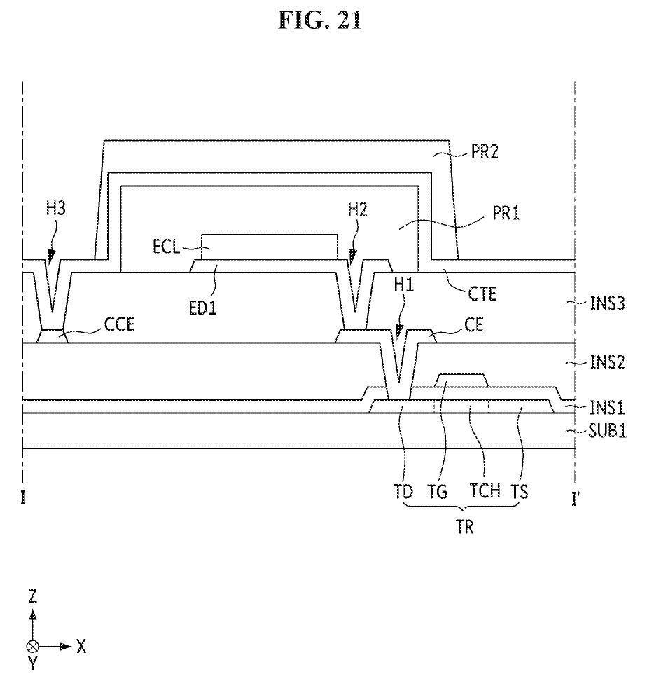

Referring to FIG. 21, the second photoresist pattern PR2 may be positioned on a portion of the counter layer CTE. The second photoresist pattern PR2 may overlap the first photoresist pattern PR1, the electrochromic layer ECL, and the pixel electrode ED1 in a third direction (e.g., a Z-axis direction). The second photoresist pattern PR2 may not be positioned on the third hole H3.

Thereafter, the counter layer CTE is etched, and the second photoresist pattern PR2 is removed (S500).

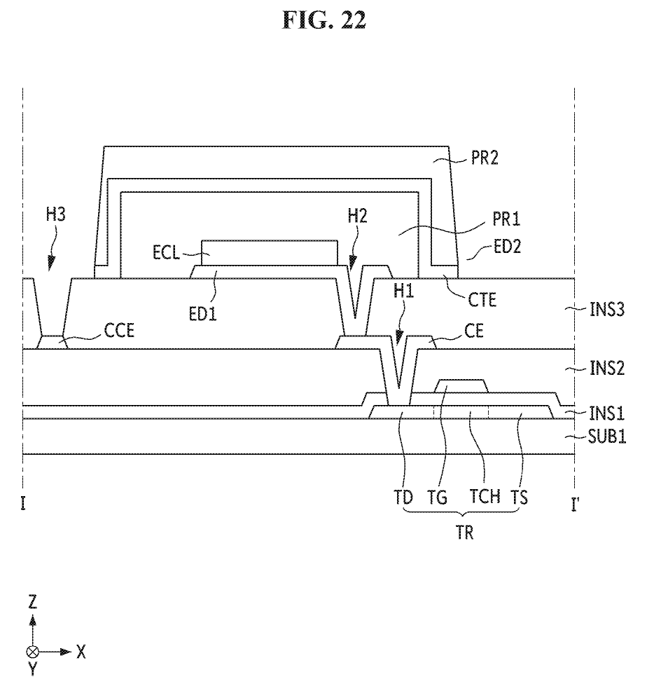

Referring to FIG. 22, the counter layer CTE may not be etched in a region where the second photoresist pattern PR2 is positioned. Accordingly, the portion of the counter layer CTE inside the third hole H3 may be etched. The cathode connection electrode CCE may be exposed through the third hole H3. Then, the second photoresist pattern PR2 may be removed.

Thereafter, a common electrode ED2 is formed on the counter layer CTE (S600).

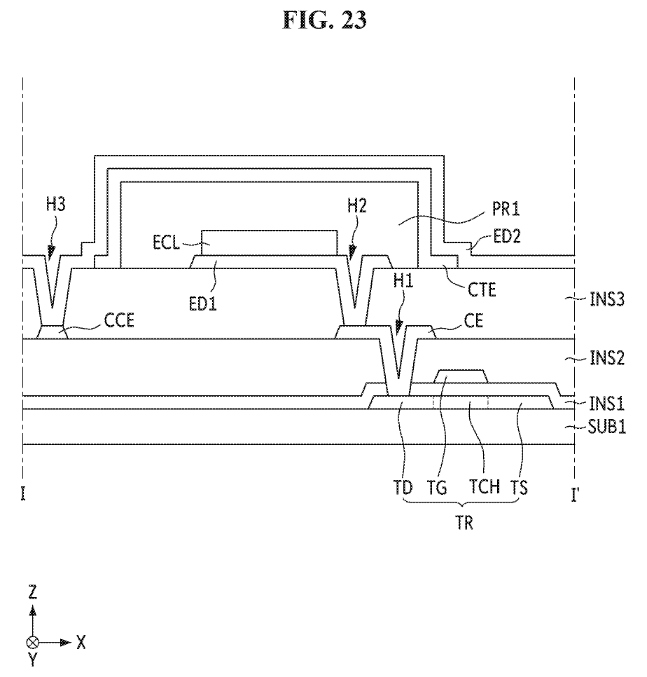

Referring to FIG. 23, the common electrode ED2 may be formed on the counter layer CTE. The common electrode ED2 may also be positioned on the third hole H3. The common electrode ED2 may be connected to the cathode connection electrode CCE through the third hole H3.

Thereafter, a third photoresist pattern PR3 is formed on a portion of the common electrode ED2 (S700).

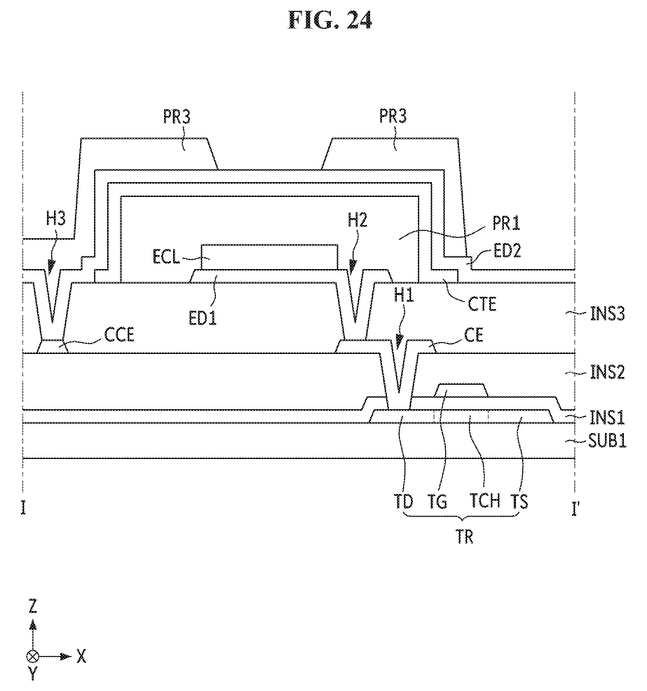

Referring to FIG. 24, the third photoresist pattern PR3 may be positioned on a portion of the common electrode ED2. The third photoresist pattern PR3 may overlap the third hole H3 in the third direction. The third photoresist pattern PR3 may not overlap the center of the electrochromic layer ECL in the third direction.

Thereafter, the common electrode ED2 is etched, and the first and third photoresist patterns PR1 and PR3 are removed (S800).

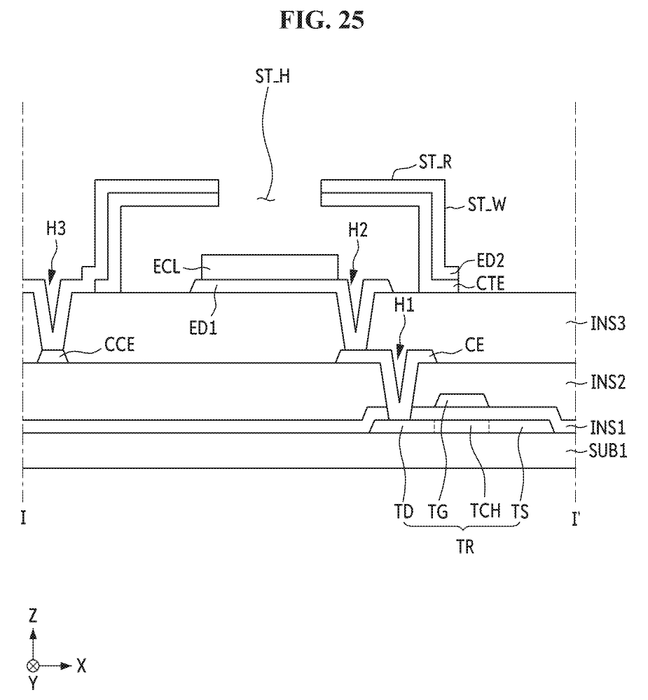

Referring to FIG. 25, the common electrode ED2 may not be etched in a region where the third photoresist pattern PR3 is positioned. Accordingly, the portion of the common electrode ED2 positioned inside the third hole H3 may not be etched. The portions of the common electrode ED2 and the counter layer CTE that overlap a central portion of the electrochromic layer ECL in the third direction may be etched, thereby forming an opening ST_H of a structural portion ST.

Thereafter, an electrolyte layer ELC is filled between the electrochromic layer ECL and the counter layer CTE and on the common electrode ED2, and a second substrate SUB2 is bonded on the electrolyte layer ELC (S900).

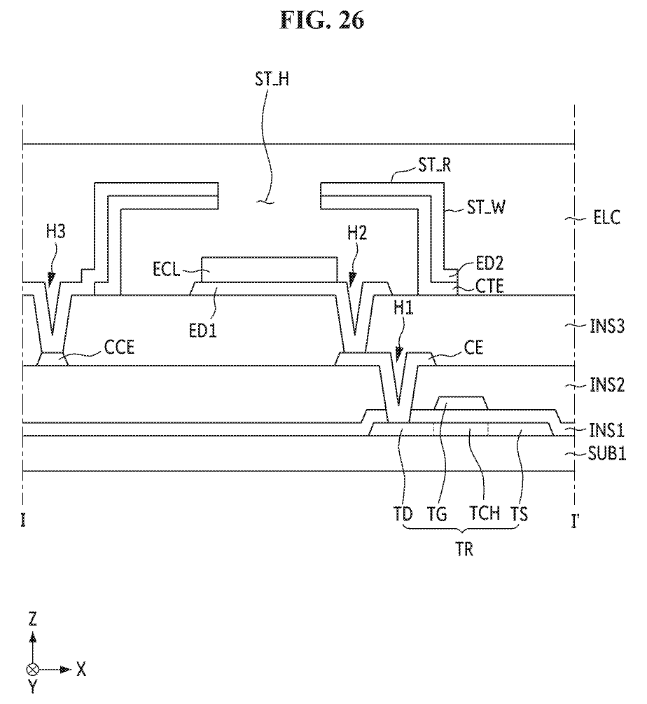

Referring to FIG. 26, the electrolyte layer ELC may be positioned on the third insulating layer INS3. The electrolyte layer ELC may also be positioned between the counter layer CTE and the electrochromic layer ECL through the opening ST_H. At this time, an air layer between the counter layer CTE and the electrochromic layer ECL may escape to the outside of the structural portion ST through the opening ST_H.

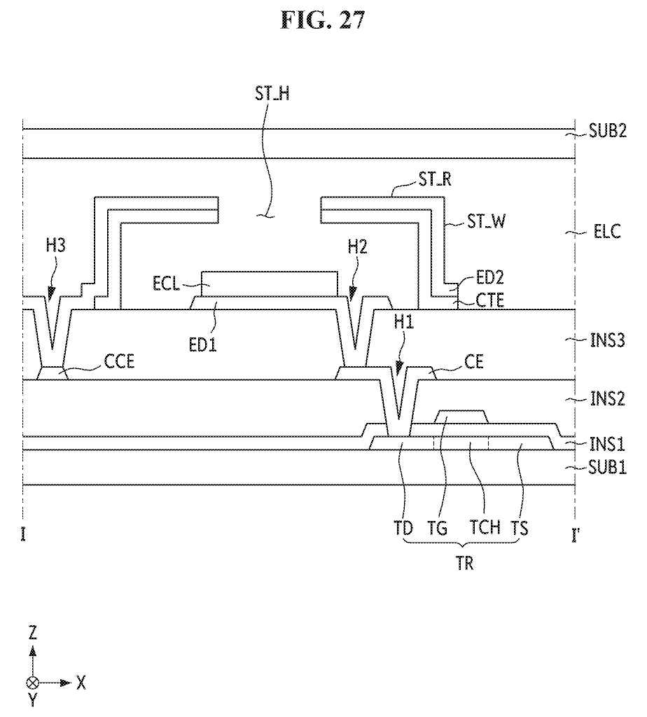

Referring to FIG. 27, the second substrate SUB2 may be positioned on the electrolyte layer ELC.

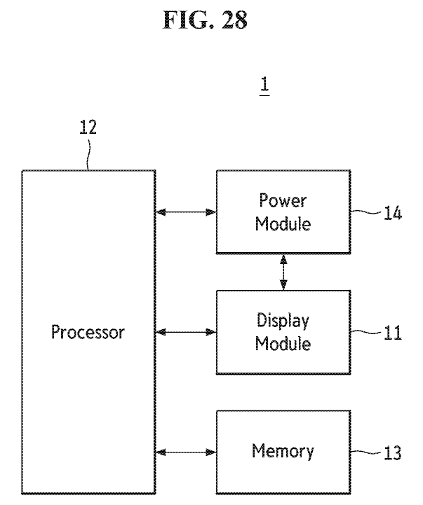

FIG. 28 is a block diagram of an electronic device including the display device according to some embodiments of the present disclosure.

Referring to FIG. 28, an electronic device 1 according to one or more embodiments may include a display module 11, a processor 13, a memory 12, and a power module 14.

The processor 13 may include at least one of a central processing unit (CPU), an application processor (AP), a graphics processing unit (GPU), a communication processor (CP), an image signal processor (ISP), or a controller.

The memory 12 may store data and information required for the operation of the processor 13 or the display module 11. When the processor 13 executes an application stored in the memory 12, image data signals and/or input control signals may be delivered to the display module 11, and the display module 11 may process the received signals to output image information through a display screen.

The power module 14 may include a power supply module, such as a power adapter or a battery device, and a power conversion module that converts power supplied by the power supply module into power required for the operation of the electronic device 1.

At least one of the aforementioned components of the electronic device 1 may be included in a display device according to any one of the aforementioned embodiments. Additionally, some of individual modules included functionally within a single module may be included in the display device, and others may be provided separately from the display device. For example, the display device may include the display module 11, while the processor 13, the memory 12, and the power module 14 may be provided as other devices included in the electronic device 1.

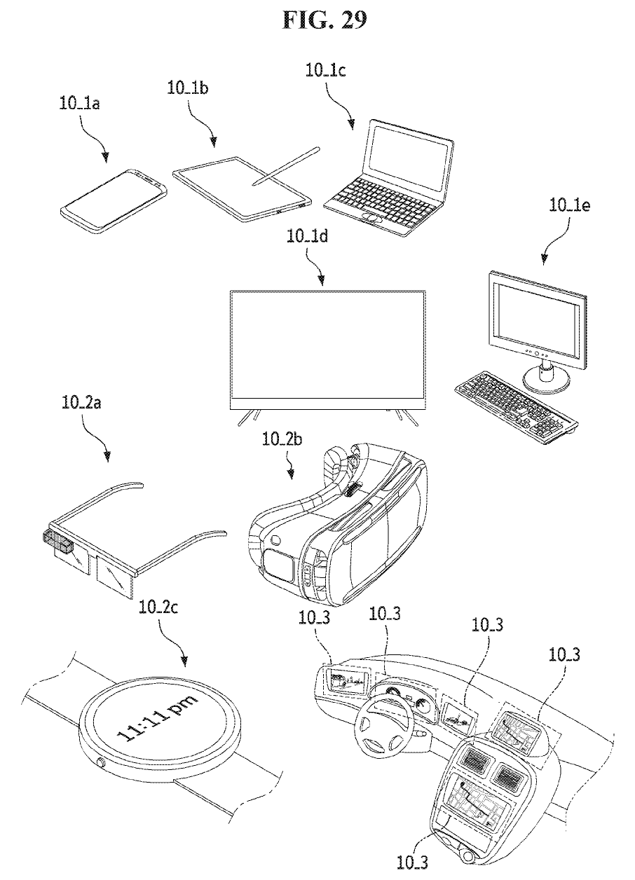

FIG. 29 illustrates schematic diagrams of electronic devices according to various embodiments.

Referring to FIG. 29, various electronic devices to which the display devices according to the embodiments are applied may include image display electronic devices, such as a smartphone 10_1a, a tablet PC 10_1b, a laptop 10_1c, a TV 10_1d, and a desktop monitor 10_1e, wearable electronic devices that include a display module, such as smart glasses 10_2a, a head-mounted display 10_2b, and a smart watch 10_2c, and vehicle electronic devices 10_3 that include a display module, such as a center information display (CID) arranged on the instrument panel, center fascia, or dashboard of a vehicle, and a room mirror display.

In concluding the detailed description, those skilled in the art will appreciate that many variations and modifications can be made to the embodiments without substantially departing from the aspects of the present disclosure. Therefore, the disclosed embodiments are used in a generic and descriptive sense only and not for purposes of limitation.

What is claimed is:

1. A display device comprising:
a substrate;
a pixel electrode above the substrate;
an electrochromic layer above the pixel electrode and configured to block or transmit light according to a redox reaction;
a counter layer spaced apart from the pixel electrode and the electrochromic layer, configured to store ions, and comprising a side portion on at least one side surface of the electrochromic layer, and a top portion connected to the side portion and defining an opening overlapping the electrochromic layer in a thickness direction of the substrate;
a common electrode above the counter layer; and
an electrolyte layer between the electrochromic layer and the counter layer.

2. The display device of claim 1, wherein the common electrode is on the side portion and the top portion.

3. The display device of claim 2, wherein the common electrode contacts the side portion and the top portion.

4. The display device of claim 1, wherein the common electrode is spaced apart from the opening in plan view.

5. The display device of claim 1, wherein the side portion of the counter layer comprises:
a first side surface;
a second side surface opposite to the first side surface;
a third side surface connecting one side of the first side surface and one side of the second side surface; and
a fourth side surface connecting another side of the first side surface and another side of the second side surface, and
wherein the top portion is connected to the first side surface, the second side surface, the third side surface, and the fourth side surface.

6. The display device of claim 5, wherein the common electrode covers the top portion, the first side surface, the second side surface, the third side surface, and the fourth side surface.

7. The display device of claim 1, wherein a planar shape of the opening is substantially equal to a planar shape of the electrochromic layer.

8. The display device of claim 1, wherein the side portion comprises a first side surface, and a second side surface opposite to the first side surface.

9. The display device of claim 8, wherein the electrochromic layer comprises:
a top surface;
a bottom surface opposite to the top surface;
a first surface connecting one side of the top surface and one side of the bottom surface;
a second surface opposite to the first surface;
a third surface connecting one side of the first surface and one side of the second surface; and
a fourth surface connecting another side of the first surface and another side of the second surface,
wherein the first side surface of the counter layer is on the first surface of the electrochromic layer,
wherein the second side surface of the counter layer is on the second surface of the electrochromic layer, and
wherein the counter layer is not on the third surface and the fourth surface of the electrochromic layer.

10. The display device of claim 9, wherein the first side surface and the second side surface of the counter layer extend in a first direction,
wherein the first side surface defines a first opening overlapping the first surface of the electrochromic layer in a second direction that is orthogonal to the first direction, and
wherein the second side surface defines a second opening overlapping the second surface of the electrochromic layer in the second direction.

11. The display device of claim 1, wherein the top portion has a circular or elliptical planar shape, and
wherein the side portion has a curved surface.

12. A display device comprising:
a substrate;
a pixel electrode above the substrate;
an electrochromic layer above the pixel electrode and configured to block or transmit light according to a redox reaction;
a counter layer spaced apart from the pixel electrode and the electrochromic layer, configured to store ions, and comprising a top portion and a side portion on at least one side surface of the electrochromic layer, connected to the top portion, and defining a first opening overlapping the electrochromic layer and a second opening opposite to the first opening in a first direction that is orthogonal to a thickness direction of the substrate;
a common electrode above the counter layer; and
an electrolyte layer between the electrochromic layer and the counter layer.

13. The display device of claim 12, wherein the first opening extends from a lower side of the side portion to a lower side of the top portion.

14. The display device of claim 12, wherein the side portion further defines a third opening overlapping the electrochromic layer and a fourth opening opposite the third opening in a second direction that is orthogonal to the thickness direction of the substrate and the first direction.

15. The display device of claim 14, wherein the third opening extends from a lower side of the side portion to a lower side of the top portion.

16. The display device of claim 12, wherein the common electrode is on the side portion and the top portion.

17. The display device of claim 16, wherein the common electrode contacts the side portion and the top portion.

18. The display device of claim 12, wherein the common electrode does not overlap the first opening and the second opening in the first direction.

19. A method for manufacturing a display device, comprising:
sequentially forming a pixel electrode and an electrochromic layer above a first substrate;
forming a first photoresist pattern above the electrochromic layer;
forming a counter layer above the first photoresist pattern;
forming a second photoresist pattern above a portion of the counter layer;
etching the counter layer and removing the second photoresist pattern;
forming a common electrode above the counter layer;
forming a third photoresist pattern above a portion of the common electrode;
etching the common electrode and removing the first and third photoresist patterns; and
filling an electrolyte layer between the electrochromic layer and the counter layer and above the common electrode.

20. An electronic device comprising:
the display device of claim 1, further comprising a display module; and
a processor configured to deliver an image data signal for displaying an image on the display module.
